(19) United States
(12) Patent Application Publication
(10) Pub. No.: US 2022/0285730 A1
(43) Pub. Date: Sep. 8, 2022

(54) ELECTROLYTE SOLUTION FOR LITHIUM SECONDARY BATTERY AND LITHIUM SECONDARY BATTERY COMPRISING SAME

(71) Applicants: Hyundai Motor Company, Seoul (KR); Kia Corporation, Seoul (KR); UNIST (Ulsan National Institute of Science and Technology), Ulsan (KR)

(72) Inventors: Ji Eun Lee, Hwaseong (KR); Jun Ki Rhee, Suwon (KR); Seung Min Oh, Incheon (KR); Yoon Sung Lee, Suwon (KR); Sung Ho Ban, Hwaseong (KR); Sang Hun Lee, Paju (KR); Woo Young Jin, Busan (KR); Sang Mok Park, Gwangju (KR); Ko Eun Kim, Cheongju (KR); Hyeon Gyu Moon, Ulsan (KR); Hui Beom Nam, Daegu (KR); Hyun Soo Ma, Gimcheon (KR); Nam Soon Choi, Ulsan (KR)

(21) Appl. No.: 17/468,193

(22) Filed: Sep. 7, 2021

(30) Foreign Application Priority Data
Mar. 8, 2021 (KR) 10-2021-0030099

(51) Int. Cl. H01M 10/0567; H01M 10/0525

(52) U.S. Cl. CPC H01M 10/0567; H01M 10/0525; H01M 2220/20; H01M 10/0568

(57) ABSTRACT

Disclosed is an additive for improving the electrochemical properties of a lithium secondary battery.

### CROSS REFERENCE TO RELATED APPLICATION

The present application claims priority to Korean Patent Application No. 10-2021-0030099, filed Mar. 8, 2021, the entire content of which is incorporated herein for all purposes by this reference.

### TECHNICAL FIELD

The present invention relates to an electrolyte solution for a lithium secondary battery and a lithium secondary battery including the electrolyte solution. The electrolyte solution particularly includes an additive that may improve electrochemical properties of a lithium secondary battery.

### BACKGROUND OF THE INVENTION

A battery is an energy storage source that can convert chemical energy into electrical energy or electrical energy into chemical energy. Batteries may be classified into non-reusable primary batteries and reusable secondary batteries. Secondary batteries have the advantage of being environmentally friendly in that they may be reused, unlike primary batteries, which are used once and discarded.

Recently, as environmental issues have emerged, demand for hybrid electric vehicles (HEVs) and electric vehicles (EVs) characterized by little or no air pollution has been increasing. In particular, EVs are vehicles from which the internal combustion engine is completely removed, and suggests the direction that the world is to take in the future.

In order for EVs to be commercialized, it is necessary to solve the problems with a battery provided in an EV. The battery provided in the EV has to be capable of driving 500 km or greater on a single charge, the power output thereof has to be equal to or higher than a predetermined level in order to use a high-performance motor, and high-speed charging has to become possible.

Accordingly, a lithium-ion battery having a high theoretical capacity and an electromotive force of 4 V or greater and of being charged and discharged at high speed may be suitably for the EV. A lithium secondary battery typically includes a cathode, an anode, an electrolyte, and a separator. At the cathode and the anode, intercalation and deintercalation of lithium ions are repeated to generate energy, and the electrolyte serves as a path through which lithium ions move. The separator plays a role of preventing a short circuit from occurring in the battery due to contact between the cathode and the anode. In particular, the cathode is closely related to the capacity of the battery, and the anode is closely related to the performance of the battery such as high-speed charging and discharging thereof.

The electrolyte includes a solvent, an additive and a lithium salt. The solvent becomes a path that helps lithium ions move between the cathode and the anode. In order for the battery to have superior performance, lithium ions have to be quickly transferred between the cathode and the anode. Therefore, selection of an optimal electrolyte in order to obtain superior battery performance is regarded as very important.

In particular, a thin film called as SEI (solid electrolyte interphase) is formed on the anode in the chemical conversion process during the production of batteries. SEI is a film that allows lithium ions to pass but not electrons, and prevents the performance of the battery from deteriorating due to side reactions caused by passing electrons through the SEI. In addition, SEI suppresses direct reactions between the electrolyte and the anode and prevents the anode from becoming detached.

The additive for the electrolyte is added in a small amount of about 0.1 to 10% based on the weight of the electrolyte. Despite the addition thereof in such a small amount, the performance and stability of the battery are greatly affected by the additive. In particular, the additive functions to induce the formation of an SEI on the surface of the anode and to control the thickness of the SEI. Moreover, the additive is capable of preventing the battery from being overcharged, and increasing the conductivity of lithium ions in the electrolyte.

For the above reasons, research and development on additives to be contained in electrolytes have been actively conducted in the industry.

The details set forth as the background art are provided for the purpose of better understanding the background of the invention, and are not to be taken as an admission that the described details correspond to the conventional technology already known to those skilled in the art.

### SUMMARY OF THE INVENTION

In preferred aspects, provided is an additive for an electrolyte solution that may be added to the electrolyte solution of a lithium secondary battery to improve the electrochemical properties of the lithium secondary battery.

In an aspect, provided is an electrolyte solution for a lithium secondary battery. The electrolyte solution may include an electrolyte salt, an organic solvent, and an additive including a compound represented by Chemical Formula 1 below.

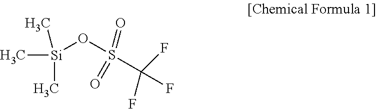

In certain embodiment, the additive is the compound represented by the Chemical Formula 1.

The electrolyte solution may suitably include compound represented by Chemical Formula 1 in an amount of about 0.2 wt % to 1.2 wt % based on the total weight of the electrolyte solution.

The electrolyte solution may suitably include the compound represented by Chemical Formula 1 in an amount of about 0.2 wt % to 0.5 wt % based on the total weight of the electrolyte solution.

The electrolyte salt may suitably include one or more selected from the group consisting of LiPF₆, LiBF₄, LiClO₄, LiCl, LiBr, LiI, LiB₁₀Cl₁₀, LiCF₃SO₃, LiCF₃CO₂, Li(CF₃SO₂)₃C, LiAsF₆, LiSbF₆, LiAlCl₄, LiCH₃SO₃, LiCF₃SO₃, LiN(SO₂C₂F₅)₂, Li(CF₃SO₂)₂N, LiC₄F₉SO₃, LiB(C₆H₅)₄, and Li(SO₂F)₂N (LiFSI).

A concentration of the electrolyte salt may be about 0.5 M to 1.0 M.

The organic solvent may include one or more selected from the group consisting of a carbonate-based solvent, an ester-based solvent, an ether-based solvent, and a ketone-based solvent.

In an aspect, provided is a lithium secondary battery including a cathode, an anode, a separator interposed between the cathode and the anode, and the electrolyte solution described herein.

The cathode may include a cathode active material including Ni, Co and Mn, and the anode may include a carbon (C)-based anode active material.

According to various exemplary embodiments of the present invention, a lithium secondary battery include the additive capable of preventing SEI from being destroyed by HF as being present in the electrolyte solution, and thus the battery has superior electrochemical performance. In particular, the lithium secondary batter as described herein excellent initial charge/discharge efficiency and excellent lifetime characteristics even at high temperatures.

Further provided are vehicles that comprise 1) electrolyte solution for a lithium secondary battery as disclosed herein. Also provided are vehicles that comprise a lithium secondary battery as disclosed herein, The vehicles may be electric-powered vehicles.

### BRIEF DESCRIPTION OF DRAWINGS

FIG. 1 is a graph showing the results of a charge/discharge efficiency test with the exemplary lithium secondary battery according to various exemplary embodiments of the present invention and comparative example;

FIG. 2 is a graph showing the results of a high-temperature lifetime test with the exemplary lithium secondary battery according to various exemplary embodiments of the present invention and comparative example; and

FIG. 3 shows SEM images of the cathode active material and the anode active material of Comparative Example and Example 2.

### DETAILED DESCRIPTION

Hereinafter, a detailed description will be given of embodiments of the present invention.

As described above, objects, other objects, features, and advantages according to the present invention will be readily understood through the following preferred embodiments associated with the accompanying drawings. However, the present invention is not limited to the embodiments described herein and may also be embodied in other forms. Rather, the embodiments introduced herein are provided so that the invention may be made thorough and complete, and the spirit according to the present invention may be sufficiently conveyed to those skilled in the art.

In this specification, it should be understood that terms such as “comprise” or “have” are intended to indicate that there is a feature, a number, a step, an operation, a component, a part, or a combination thereof described on the specification, and do not exclude the possibility of the presence or the addition of one or more other features, numbers, steps, operations, components, parts, or combinations thereof. Further, when a portion such as a layer, a film, a region, or a plate is referred to as being “above” the other portion, it may be not only “right above” the other portion, or but also there may be another portion in the middle. On the contrary, when a portion such as a layer, a film, a region, or a plate is referred to as being “under” the other portion, it may be not only “right under” the other portion, or but also there may be another portion in the middle.

Unless otherwise indicated, all numbers, values, and/or expressions referring to quantities of ingredients, reaction conditions, polymer compositions, and formulations used herein are to be understood as modified in all instances by the term “about” as such numbers are inherently approximations that are reflective of, among other things, the various uncertainties of measurement encountered in obtaining such values.

Further, unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Further, where a numerical range is disclosed herein, such range is continuous, and includes unless otherwise indicated, every value from the minimum value to and including the maximum value of such range. Still further, where such a range refers to integers, unless otherwise indicated, every integer from the minimum value to and including the maximum value is included.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

A lithium secondary battery generates heat during discharge, and the temperature increases as it is used. The optimal temperature for a lithium secondary battery is in the range of 15° C. to 40° C. If the battery is used outside this range, the performance of the battery deteriorates.

Specifically, when the battery is used at a low temperature, the activity of chemical materials may decrease, and the internal resistance of the battery may increase, resulting in a sharp drop in voltage and a rapid decrease in discharge capacity. On the other hand, when the battery is used at a high temperature, the activity of chemical materials may increase, and discharge of 100% or greater may occur, resulting in deteriorated battery performance due to additional chemical reactions.

In particular, since Korea has four seasons in regions with wide temperature fluctuation, EVs are capable of operating without problems only when provided with a battery having stable performance even in the temperature range of −40° C. to 60° C.

Thus, the battery is typically tested under extreme conditions. In particular, the high-temperature lifetime characteristics, that is, the ability to maintain the lifespan of the battery without degradation thereof even when the battery is used at high temperatures, has become an important evaluation criterion.

Meanwhile, many complex chemical reactions occur inside the lithium secondary battery. Among these chemical reactions, reactions that degrade the battery must be suppressed as much as possible in order to maintain the electrochemical properties of the battery. Among other things, particular concern is about HF that is produced by the reaction of lithium salt LiPF₆ and a small amount of water in the electrolyte solution. HF may destroy SEI formed on the anode in the initial chemical conversion step, and may react with the active material at the cathode to thus dissolve the metal ions of the active material.

Therefore, the lithium secondary battery requires an HF scavenger for removing HF that may be generated in the electrolyte solution.

The electrolyte solution as described herein is an electrolyte solution for a lithium secondary battery including an electrolyte salt, an organic solvent, and an additive including a compound represented by Chemical Formula 1 below, or trimethylsilyl trifluoromethanesulfonate.

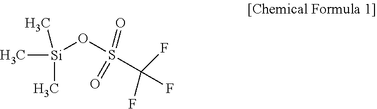

The additive may be a compound represented by the Chemical Formula 1.

The additive of trimethylsilyl trifluoromethanesulfonate may react with HF in the lithium secondary battery, thereby removing HF.

For example, trimethylsilyl trifluoromethanesulfonate may react with HF to produce the following compounds.

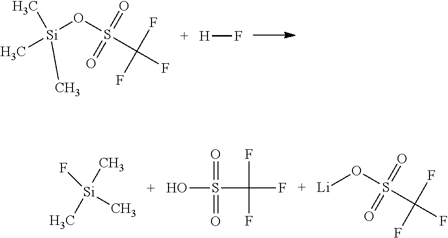

Through the above reaction, trimethylsilyl trifluoromethanesulfonate may scavenge HF. Hereinafter, the results of tests on electrochemical properties, performed by manufacturing a lithium secondary battery using the additive, are described.

Lithium Secondary Battery

The lithium secondary battery of the present invention includes a cathode, an anode, a separator interposed between the cathode and the anode, and an electrolyte solution as described herein.

The cathode includes an NCM-based cathode active material composed of Ni, Co and Mn, and preferably NCM811 may be suitably used. Examples of the cathode active material include LiCoO₂, LiMnO₂, LiNiO₂, LiNi₁₋ₓCoₓO₂, LiNi_{0.5}Mn_{0.5}O₂, LiMn₂₋ₓMₓO₄ (in which M is Al, Li or a transition metal), LiFePO and the like, and any other cathode active materials capable of being used for lithium secondary batteries may be used.

The cathode may further include a conductor and a binder.

The conductor may impart conductivity to the electrode, and in the battery, any material may be used, so long as it does not cause chemical changes and is an electron conductive material. For example, natural graphite, artificial graphite, carbon black, acetylene black, Ketjen black, carbon fiber, metal powder such as copper, nickel, aluminum, silver, metal fiber, etc. may be used, and conductive materials such as polyphenylene derivatives, etc. may be used alone or in combinations of two or more.

The binder serves to attach the particles of the active material well to each other or to a current collector in order to mechanically stabilize the electrode. Preferably, the binder may stably fix the active material during repeated intercalation and deintercalation of lithium ions to prevent the bond between the active material and the conductor from loosening. Examples of the binder may include, but are not limited to, polyvinyl alcohol, carboxymethyl cellulose, hydroxypropyl cellulose, diacetyl cellulose, polyvinyl chloride, carboxylated polyvinyl chloride, polyvinyl fluoride, ethylene-oxide-containing polymer, polyvinylpyrrolidone, polyurethane, polytetrafluoroethylene, polyvinylidene fluoride, polyethylene, polypropylene, styrene butadiene rubber, acrylated styrene butadiene rubber, epoxy resin, nylon, etc.

The anode includes a carbon (C)-based anode active material, and at least one material selected from the group consisting of artificial graphite, natural graphite, graphitized carbon fiber, graphitized mesocarbon microbeads, fullerene, and amorphous carbon may be used. In particular, graphite is used in the present embodiment.

Like the cathode, the anode may further include a binder and a conductor.

The electrolyte solution is composed of an organic solvent and an additive.

The organic solvent may include one or more selected from the group consisting of a carbonate-based solvent, an ester-based solvent, an ether-based solvent, and a ketone-based solvent.

For example, the carbonate-based solvent may include dimethyl carbonate (DMC), diethyl carbonate (DEC), dipropyl carbonate (DPC), methylpropyl carbonate (MPC), ethylpropyl carbonate (EPC), ethylmethyl carbonate (EMC), ethylene carbonate (EC), propylene carbonate (PC), butylene carbonate (BC), fluoroethylene carbonate (FEC), vinylene carbonate (VC), and the like. Examples of the ester-based solvent may include γ-butyrolactone (GBL), n-methyl acetate, n-ethyl acetate, n-propyl acetate, etc., and examples of the ether-based solvent may include dibutyl ether, etc., but the present invention is not limited thereto.

The solvent may further include an aromatic-hydrocarbon-based organic solvent. Preferably, the aromatic-hydrocarbon-based organic solvent include benzene, fluorobenzene, bromobenzene, chlorobenzene, cyclohexylbenzene, isopropylbenzene, n-butylbenzene, octylbenzene, toluene, xylene, mesitylene, and the like, which may be used alone or in combination.

The separator prevents a short circuit between the cathode and the anode and provides a path through which lithium ions move. Examples of the separator may include polyolefin-based polymer membranes such as polypropylene, polyethylene, polyethylene/polypropylene, polyethylene/polypropylene/polyethylene, polypropylene/polyethylene/polypropylene, etc., or multilayers thereof, microporous films, woven fabrics, and nonwoven fabrics, as known in the art. In addition, a film obtained by coating the porous polyolefin film with a resin having superior stability may be used.

Manufacture of Batteries of Comparative Example and Examples

Manufacture of Cathode

In order to manufacture a cathode, PVdF was dissolved in NMP to afford a binder solution.

The binder solution was mixed with a cathode active material and carbon black serving as a conductor to afford a slurry, which was then applied onto both sides of an aluminum foil and dried.

Thereafter, a rolling process and a drying process were performed, followed by ultrasonically welding the aluminum tab, thereby manufacturing a cathode. In the rolling process, the electrode density was adjusted to 3.3 g/cc.

Here, Li[Ni_{0.8}Co_{0.1}Mn_{0.1}]O₂, in which Ni, Co and Mn are mixed at a ratio of 8:1:1, was used as the cathode active material.

Manufacture of Anode

A slurry was prepared by mixing a binder solution prepared for the manufacture of an anode with an anode active material, and the slurry was applied onto both sides of a copper foil and then dried.

Thereafter, a rolling process and a drying process were performed, followed by ultrasonically welding the nickel electrode, thereby manufacturing an anode. In the rolling process, the electrode density was adjusted to 1.6 g/cc.

Here, graphite was used as the anode active material.

Manufacture of Electrolyte Solution

As an organic solvent, a mixture of ethylene carbonate (EC), ethylmethyl carbonate (EMC), and diethyl carbonate (DEC) at a volume ratio of 25:45:30 was used. As lithium salts, 0.5 M LiPF₆ and 0.5 M LiFSI were dissolved in the solvent, and the resulting electrolyte solution was injected. In addition, according to each example, trimethylsilyl trifluoromethanesulfonate as an additive was added in different amounts to the organic solvent.

Manufacture of Pouch Cell

A separator was interposed between the cathode and the anode and wound to form a jelly roll. A pouch cell was manufactured using the jelly roll and the electrolyte solution.

### COMPARATIVE EXAMPLE

A battery in which no additive was used in the electrolyte solution was used.

### EXAMPLE 1

A battery in which 0.2 wt % of an additive was added based on the total weight of the electrolyte solution was used.

### EXAMPLE 2

A battery in which 0.5 wt % of an additive was added based on the total weight of the electrolyte solution was used.

### EXAMPLE 3

A battery in which 0.7 wt % of an additive was added based on the total weight of the electrolyte solution was used.

### EXAMPLE 4

A battery in which 1.0 wt % of an additive was added based on the total weight of the electrolyte solution was used.

### EXAMPLE 5

A battery in which 1.2 wt % of an additive was added based on the total weight of the electrolyte solution was used.

Evaluation of Initial Charge/Discharge Efficiency Using Manufactured Battery

A test was conducted to evaluate the initial charge capacity and discharge capacity of the batteries manufactured according to Comparative Example and Examples. The evaluation of initial charge/discharge efficiency serves to evaluate the first charge/discharge efficiency after completion of the manufacture of the battery. Evaluation of initial charge/discharge efficiency is an important item in evaluating the electrochemical performance of a battery because SEI is formed in the initial charging stage and is maintained until the end of the lifetime of the battery. Here, the discharge-end voltage and the charge-end voltage were set to 2.5 V and 4.2 V, respectively, and the C-rate was set to 1C. The test was performed at a temperature of 45° C.

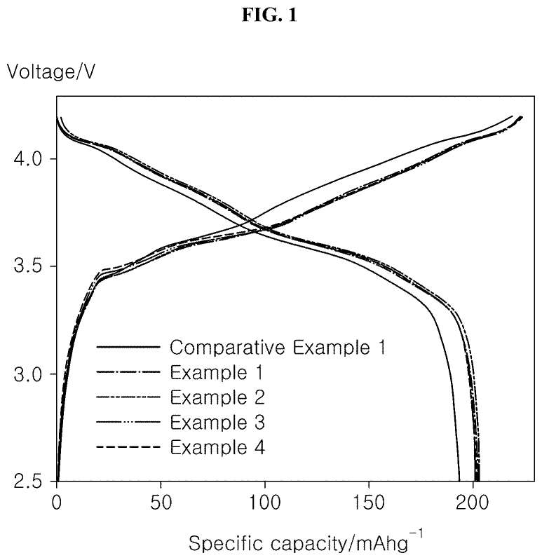

The test results are shown in Table 1 below, and are graphed in FIG. 1.

TABLE 1

| | | Initial | Initial | Initial |
|---|---|---|---|---|
| | | charge | discharge | charge/discharge |
| | Amount of | capacity | capacity | efficiency |
| | additive | (mAh/g) | (mAh/g) | (%) |
| Comparative | — | 219 | 194 | 88.5 |
| Example 1 | | | | |
| Example 1 | 0.2 | 223 | 203 | 91.0 |
| Example 2 | 0.5 | 223 | 202 | 90.6 |
| Example 3 | 0.7 | 223 | 202 | 90.6 |
| Example 4 | 1.0 | 224 | 202 | 90.2 |
| Example 5 | 1.2 | 223 | 202 | 90.4 |

Based on the above test results, when the amount of the additive was 0.2%, the best initial charge/discharge efficiency of 91.0% was exhibited, and 0.5% and 0.7% showed the second best initial charge/discharge efficiency of 90.6%. When the amount of the additive was 1.2%, the third best initial charge/discharge efficiency of 90.4% was exhibited, and the use of 1.0% resulted in the fourth best initial charge/discharge efficiency of 90.2%.

Evaluation of Initial Cell Resistance and High-Temperature Lifetime Using Manufactured Battery

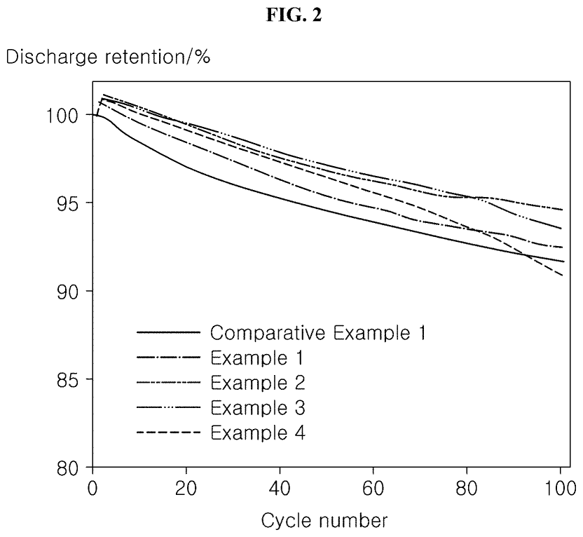

A test was conducted to evaluate the initial cell resistance and high-temperature lifetime of the batteries manufactured according to Comparative Example and Examples. The discharge-end voltage and the charge-end voltage were set to 2.5 V and 4.2 V, respectively, and the C-rate was set to 1C. The test was performed at a temperature of 45° C. The results up to 100 cycles are shown in FIG. 2.

The test results are shown in Table 2 below.

TABLE 2

| | | Initial cell | High-temperature |
|---|---|---|---|
| | Amount of | resistance | lifetime |
| | additive | (%) | (%) |
| Comparative | — | 100 | 91.7 |
| Example | | | |
| Example 1 | 0.2 | 98 | 92.5 |
| Example 2 | 0.5 | 97 | 94.7 |
| Example 3 | 0.7 | 101 | 93.6 |
| Example 4 | 1.0 | 103 | 91.1 |
| Example 5 | 1.2 | 106 | 82.0 |

Based on the above test results, Example 2 (in which the amount of the additive was 0.5%) exhibited the best high-temperature lifetime of 94.7% and the lowest initial cell resistance. Example 3 (in which the amount of the additive was 0.7%) showed a high-temperature lifetime of 93.6%, but the initial resistance thereof was 1% higher than that of Comparative Example. Example 1 (in which the amount of the additive was 0.2%) showed a high-temperature lifetime of 92.5% and low initial cell resistance compared to Comparative Example. Example 4 (in which the amount of the additive was 1.0%) exhibited a high-temperature lifetime of 91.1% and a low high-temperature lifetime and high initial cell resistance compared to Comparative Example. Example 5 (in which the amount of the additive was 1.2%) exhibited a high-temperature lifetime of 82.0%, indicating that the battery was rapidly degraded under high-temperature conditions.

As is apparent from the above test results, when the amount of the additive was 0.2 to 1.2% based on the weight of the electrolyte solution, the initial charge/discharge efficiency was greater than that of Comparative Example. However, when the amount of the additive was 1.0% and 1.2%, the high-temperature lifetime was lower than that of Comparative Example. Therefore, the amount of the additive may range from 0.2 to 1.2%, and preferably from 0.2 to 0.7%, based on the weight of the electrolyte solution.

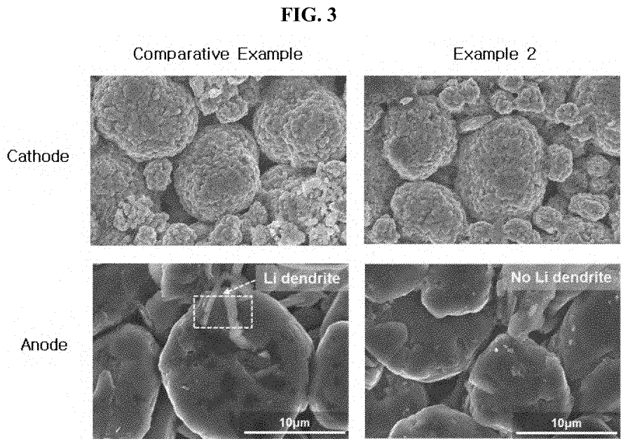

This is deemed to be because the electrochemical properties of the lithium secondary battery are increased due to the HF-scavenging effect of trimethylsilyl trifluoromethanesulfonate serving as the additive. In addition, as shown in FIG. 3, based on the results of observation of the cathode active material and the anode active material using an SEM after 100 charge and discharge cycles, the cathode particles were broken and the battery was able to be degraded in the lower left of the SEM image of Comparative Example, and lithium metal was precipitated on the anode to form a dendritic phase, whereas, in the battery including the additive (Example 2), the degradation of the cathode particles was relatively small, and a lithium dendritic phase did not appear on the anode.

Although various exemplary embodiments of the present invention have been disclosed for illustrative purposes, the present invention is not limited thereto, and is defined by the accompanying claims. Therefore, those skilled in the art will appreciate that various modifications, additions and substitutions are possible, without departing from the scope and spirit of the invention as disclosed in the accompanying claims.

What is claimed is:

1. An electrolyte solution for a lithium secondary battery, comprising:
an electrolyte salt;
an organic solvent; and an additive comprising a compound represented by Chemical Formula 1 below.

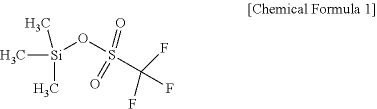

2. The electrolyte solution of claim 1, wherein the electrolyte solution comprises the compound represented by Chemical Formula 1 in an amount of about 0.2 wt % to 1.2 wt % based on the total weight of the electrolyte solution.

3. The electrolyte solution of claim 1, wherein the electrolyte solution comprises the compound represented by Chemical Formula 1 in an amount of about 0.2 wt % to 0.7 wt % based on the total weight of the electrolyte solution.

4. The electrolyte solution of claim 1, wherein the electrolyte salt comprises one or more selected from the group consisting of LiPF₆, LiBF₄, LiClO₄, LiCl, LiBr, LiI, LiB₁₀Cl₁₀, LiCF₃SO₃, LiCF₃CO₂, Li(CF₃SO₂)₃C, LiAsF₆, LiSbF₆, LiAlCl₄, LiCH₃SO₃, LiCF₃SO₃, LiN(SO₂C₂F₅)₂, Li(CF₃SO₂)₂N, LiC₄F₉SO₃, LiB(C₆H₅)₄, and Li(SO₂F)₂N (LiFSI).

5. The electrolyte solution of claim 1, wherein a concentration of the electrolyte salt is about 0.5 M to 1.0 M.

6. The electrolyte solution of claim 1, wherein the organic solvent comprises one or more selected from the group consisting of a carbonate-based solvent, an ester-based solvent, an ether-based solvent, and a ketone-based solvent.

7. A lithium secondary battery comprising a cathode, an anode, a separator interposed between the cathode and the anode, and the electrolyte solution of claim 1.

8. The lithium secondary battery of claim 7, wherein the cathode comprises a cathode active material comprising Ni, Co and Mn, and the anode comprises a carbon (C)-based anode active material.

9. A vehicle that comprises a battery of claim 7.
